(19) United States
(12) Patent Application Publication
(10) Pub. No.: US 2026/0099426 A1
(43) Pub. Date: Apr. 9, 2026

(54) DYNAMIC INSTRUMENTATION FOR SOFTWARE APPLICATIONS

(71) Applicant: Cisco Technology, Inc., San Jose, CA (US)

(72) Inventors: Rahul Singh, Bengaluru (IN); Ashutosh Goel, Bangalore (IN); Sanket Nalinkant Mehta, Bangaluru (IN)

(21) Appl. No.: 18/799,162

(22) Filed: Aug. 9, 2024

(51) Int. Cl. G06F 11/36

(52) U.S. Cl. CPC G06F 11/3616

(57) ABSTRACT

Techniques are provided for injecting dynamic instrumentation to software applications. A method includes a telemetry agent initiating an observability session with a software application and altering an import statement of the software application to generate one or more proxy objects. The method further includes the telemetry agent determining one or more instrumentations based on a configuration file for the observability session and instantiating the one or more instrumentations in the software application using the one or more proxy objects.

### TECHNICAL FIELD

The present disclosure relates to capturing telemetry data using dynamic instrumentation.

### BACKGROUND

Telemetry agents monitor and collect performance measurements data of software applications by injecting instrumentation into an application at runtime. One technique for injecting instrumentation is called monkey patching, which updates behaviors of a software application by modifying a selection of program code at runtime without changing the entire code. For example, in an observability session, telemetry agents can inject instrumentation into a software application to capture performance measurements (e.g., execution time) of various functions in the application. The resulting performance measurements can be analyzed to detect anomalies in application behavior.

### BRIEF DESCRIPTION OF THE DRAWINGS

FIG. 1 is a block diagram illustrating a system for providing an observability session, according to an example embodiment.

FIG. 2 is an operational flow diagram illustrating a system for providing an observability session based on a configuration file, according to an example embodiment.

FIG. 3 is a diagram illustrating a graphical user interface displaying a performance metrics dashboard, according to an example embodiment.

FIG. 4 is a block diagram of a system for providing observability sessions between telemetry agents and applications, according to an example embodiment.

FIG. 5A illustrates a program with code for patching an import statement, according to an example embodiment.

FIG. 5B illustrates a program that comprises code for monkey patching classes/methods.

FIG. 6 illustrates a program with code for implementing module patching, according to an example embodiment.

FIG. 7A illustrates a program receiving instrumentation through import patching, according to an example embodiment.

FIG. 7B illustrates instrumentation results from the program shown in FIG. 7A, according an example embodiment.

FIG. 8A illustrates a program being instrumented without import patching.

FIG. 8B is a diagram illustrating instrumentation results from the program shown in FIG. 8A.

FIG. 9 is a flow chart depicting a method for instantiating one or more instrumentations in a software application using one or more proxy objects, according to an example embodiment.

FIG. 10 is a hardware block diagram of a computing device configured to perform one or more techniques presented herein.

### DETAILED DESCRIPTION

### Overview

Techniques are provided for injecting dynamic instrumentation into software applications. In one embodiment, a method includes a telemetry agent initiating an observability session with a software application and altering an import statement of the software application to generate one or more proxy objects. The method further includes the telemetry agent determining one or more instrumentations based on a configuration file for the observability session and instantiating the one or more instrumentations in the software application using the one or more proxy objects.

### Example Embodiments

As described above, telemetry agents may use monkey patching to inject instrumentation during application bootup, which means that new classes/methods cannot be instrumented during runtime. In other words, if a class, method, or module is patched after bootup has happened, the patch does not take effect if a user of a library has already imported the class, method, or module. As such, users are locked into the instrumented classes after the applications are executed and cannot add instrumentation criteria to instrument/gather data from applications during runtime.

For example, based on performance measurements reported by the telemetry agent in an ongoing observability session, the user may identify that additional instrumentation is needed. However, current telemetry agents lack the flexibility to inject instrumentation while the application is running, which means new functions cannot be instrumented without requiring agent upgrade and/or restart. As such, current techniques of injecting instrumentation during runtime often result in the generation of incorrect measurements. A dynamic instrumentation that provides users with timely and accurate performance measurements can overcome these shortcomings of current telemetry agents.

Telemetry data, sometimes called “collection data” or “measurement data”, are values obtained from monitoring i.e., monitoring by monitoring agent performance of one or more web pages and/or software applications (e.g., mobile, web, or desktop applications). The telemetry data includes various information such as identifiers, timestamps, performance measurements, etc.

Techniques are presented herein to dynamically instantiate instrumentation in a software application during runtime, thus providing improved flexibility and enhanced consistency in application performance measurement (APM) monitoring.

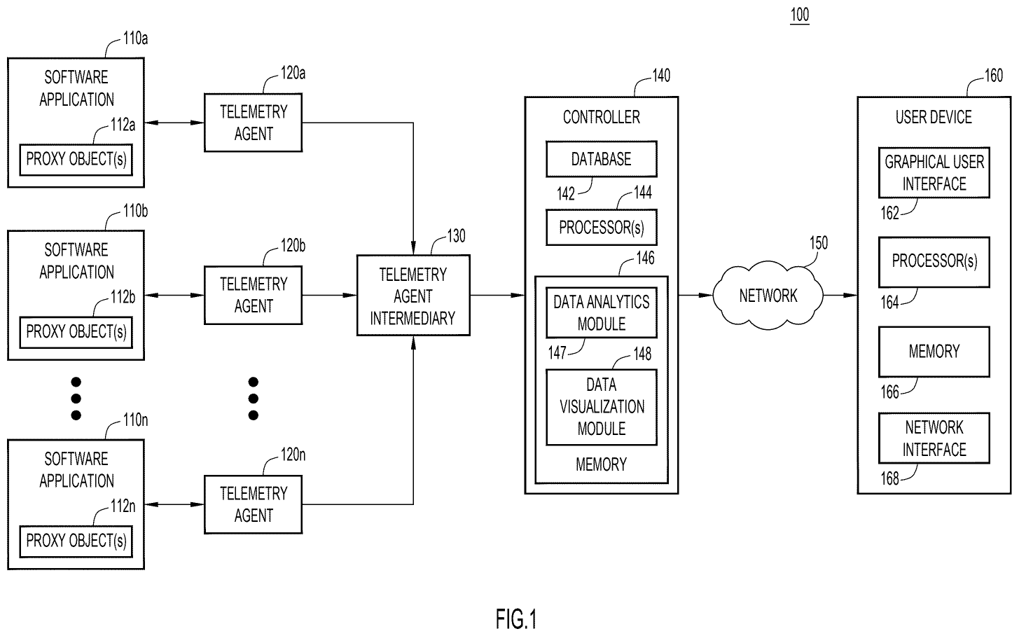

Reference is first made to FIG. 1, for a description of a block diagram illustrating a system 100 for providing an observability session, according to an example embodiment. The system 100 includes a plurality of software applications 110a, 110b, . . . 110n (also collectively denoted 110a-n), a plurality of telemetry agents 120a, 120b, . . . 120n (also collectively denoted 120a-n, a telemetry agent intermediary 130, a controller 140, a network 150, and a user device 160. The notation “a-n” denotes that a number is not limited, can vary widely, and depends on a particular use case scenario.

The system 100 is configured to establish an observability session for monitoring and collecting telemetry data (e.g., application performance measurements) associated with a software application. In the system 100, the telemetry agents 120a-n initiate one or more observability sessions with the software applications 110a-n. An observability session is initiated by installing one or more telemetry agents on a target software application. The telemetry agents 120a-n are software modules or applications configured to monitor and collect telemetry data as directed by the controller 140. The software applications 110a-n can be a mobile application, a web application, a desktop application, or any software program executable by a processor. Although FIG. 1 illustrates, by way of example, a one-to-one correspondence between the software applications 110a-n and the telemetry agents 120a-n, it should be understood that multiple telemetry agents may initiate observability sessions with a given software application.

Each of the telemetry agents 120a-n can perform one or more same or different performance measurement tasks. In one example, telemetry agent 120a tracks execution time associated with functions of a software application, while telemetry agent 120b monitors application availability. In another example, both telemetry agent 120a and telemetry agent 120b can track execution time and/or monitor application availability. Other performance measurements that can be monitored include response time, central processing unit (CPU) usage, memory usage, error rate, or any suitable metrics indicative of the performance of a software application.

In an observability session, the telemetry agents 120a-n instantiate one or more instrumentations in the software applications 110a-n using one or more proxy objects 112a, 112b, . . . 112n (collectively 112a-n) at runtime. The one or more instrumentations modify behaviors of the software applications 110a-n by inserting code, deleting code, or updating the code of the software applications 110a-n. The type of instrumentation applied depends on the performance measurement task assigned to a particular telemetry agent. Further aspects associated with the operations of using proxy objects to instantiate instrumentation in the software applications 110a-n will be described below.

The telemetry agents 120a-n are communicatively connected to the telemetry agent intermediary 130. The telemetry agent intermediary 130 is a computer program or module that facilitates communication between the telemetry agents 120a-n and controller 140. The telemetry agents 120a-n report to the telemetry agent intermediary 130 performance measurements collected from the software applications 110a-n based on one or more instrumentations. The telemetry agent intermediary 130 then provides the performance measurements to the controller 140.

In some embodiments, the telemetry agent intermediary 130 is assigned to more than one telemetry agent in a multi-tenant implementation. In other embodiments, the telemetry agent intermediary 130 is assigned to one telemetry agent in a single-tenant implementation. The telemetry agent intermediary 130 can be launched manually or automatically when at least one of the telemetry agents 120a-n is launched.

The controller 140 includes a database 142, one or more processors 144, and a memory 146. The one or more processors 144 are configured to perform one or more operations of the controller 140. The database 142 is configured to store one or more data (e.g., performance measurements), metadata (e.g., observability session identifier), or other information associated with the observability session established by the system 100. The controller 140 communicates with the user device 160 via the network 150. In certain embodiments, the controller 140 is a server. It should be understood that there may be multiple controllers in a given system deployment to enable load balancing the serving of multiple observability sessions.

The memory 146 includes instructions for various software programs/modules to be executed by the one or more processors 144 to carry out certain aspects of the techniques presented herein. For example, the memory 146 includes instructions for a data analytics module 147 and a data visualization module 148. The data analytics module 147 processes and analyzes the performance measurements reported by the telemetry agents 120a-n to generate data processing and analytics results. The data analytics module 147 uses artificial intelligence, machine learning, or any suitable technique to process and analyze the performance measurements. The data visualization module 148 generates one or more visualizations (e.g., graphs, charts, visual reports, etc.) associated with the data processing and analytics results provided by the data analytics module 147.

The network 150 may include a local area network (LAN), a wide area network (WAN) such as the Internet, or a combination thereof, and includes wired, wireless, or fiber optic connections. In general, the network 150 can use any combination of connections and protocols that support communications between the entities of the system 100, such as communications between the controller 140 and the user device 160. For example, the controller 140 transmits the one or more reports and/or visualizations of the performance measurements to the user device 160.

The user device 160 includes a graphical user interface 162, one or more processors 164, a memory 166, and a network interface 168. The memory 166 includes instructions for various software programs/modules to be executed by the one or more processors 164 to carry out certain aspects of the techniques presented herein. The graphical user interface 162 displays the one or more reports and/or visualizations obtained from the controller 140. Further, the graphical user interface 162 renders modifications to the displayed information based on input(s) received from a user and/or based on data received from the controller 140. The network interface 168 enables communications between the user device 160 and other systems, entities, etc. to facilitate operations for various embodiments described herein.

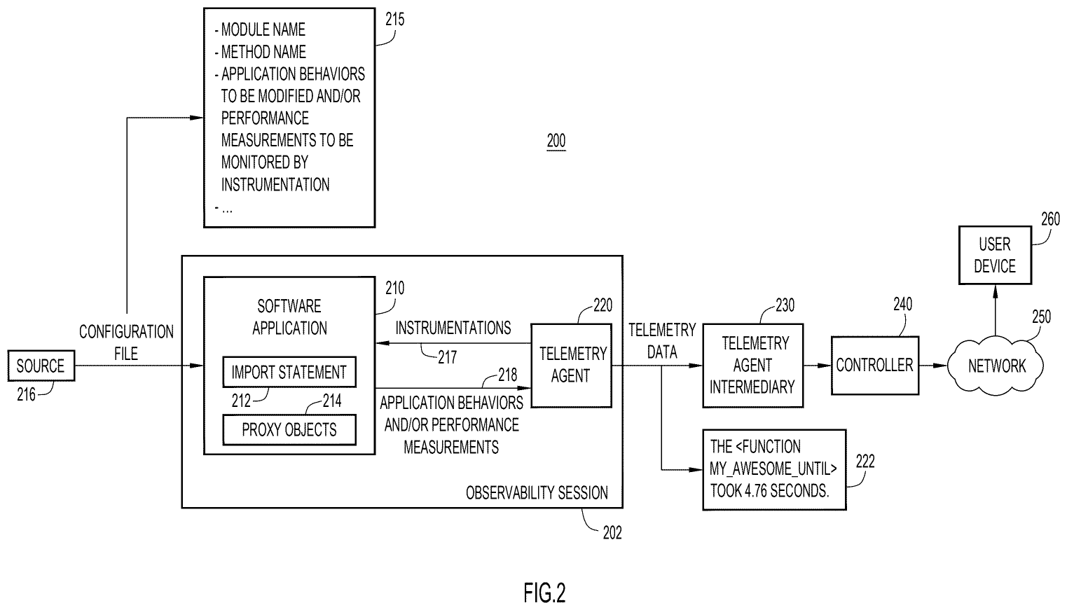

FIG. 2 is an operational flow diagram of a system 200 for providing an observability session based on a configuration file, according to an example embodiment. In the system 200, a software application 210 is initiated with instructions to launch a process configured to initiate a telemetry agent 220 on bootup. In certain embodiments, an autoinject script/code is used to initiate the telemetry agent 220. Once the telemetry agent 220 is initiated on bootup, the telemetry agent 220 establishes an observability session 202 with the software application 210.

The software application 210 is implemented by a computer program containing a sequence of instructions (or code) executable by one or more processors. The computer program contains one or more import statements that enable the computer program to import one or more modules or libraries into the computer program. The computer program can be written in Python, Java, C, or any suitable programming language.

After the telemetry agent 220 is initiated, the telemetry agent 220 patches an import statement 212 in the code of the software application 210 to generate one or more proxy objects 214. Instead of directly modifying behaviors of methods and classes in the software application using patching techniques such as monkey patching, the telemetry agent 220 patches the import statement to alter the behavior of the import statement. For example, the import statement 212 is patched such that it returns proxy objects instead of original objects. In one embodiment, a Python implementation uses the “_builtins_._import_” method to monkey patch the import statement to generate proxy objects. The import statement 212 can be a direct or indirect import statement.

The one or more proxy objects 214 have the same behaviors as original objects in the software application 210. That is, for example, proxy methods are created for methods in the program, and proxy classes are created for classes in the program. Each proxy method/class mimics the behavior of the respective original method/class.

The one or more proxy objects 214 of the software application 210 are configured to accept a configuration file 215 from a source 216 during runtime. The source 216 can be a file, a third-party server, a database, a user's own implementation, an intermediary between a telemetry agent and a controller, or any source suitable for providing configuration instructions. The configuration file 215 contains information identifying how the one or more proxy objects 214 should generate telemetry data. The configuration file 215 specifies a class, a module, a method, and/or a function to be instrumented by the telemetry agent 220 as well as information detailing the instrumentations to be performed. For example, the instrumentations can include modifications to application behavior and/or tracking of performance measurements. An example configuration file is provided as follows:

{
“module”: “from_class”,
“method”: “my_awesome_util”,
“behaviours”: [“REPORT_DURATION”, “CREATE_SPAN”,
“GENERATE_ANALYTICS”]
}

In the above example, the configuration file 215 received by the one or more proxy objects 214 specifies the module “from_class” and the method “my_awesome_util” are instrumented. More specifically, the instrumentations involve reporting duration of module/method execution, creating a span, and generating analytics for the identified module and method. Other performance measurements that can be monitored include response time, CPU usage, memory usage, error rate, or any suitable metric indicative of the performance of a software application. Moreover, how the one or more proxy objects 214 uses the configuration file 215 depends on an objective of the observability session 202.

Based on the configuration file 215, the telemetry agent 220 instantiates one or more instrumentations 217 using the one or more proxy objects 214 by inserting the one or more instrumentations 217 into the software application 210. Then, the telemetry agent 220 monitors and tracks application behaviors and/or performance measurements 218 in response to the one or more instrumentations 217.

The telemetry agent 220 reports telemetry data 222 resulting from the observability session 202 to a telemetry agent intermediary 230. The telemetry data 222 include some or all of the application behaviors and/or performance measurements 218 monitored by the telemetry agent 220. For example, the telemetry agent 220 reports to the telemetry agent intermediary 230 the following telemetry data 222: “The <function my_awesome_until> took 4.76 seconds.” In this example, the telemetry agent 220 reports the name and execution duration of a specific function in the software application 210 to the telemetry agent intermediary 230.

The telemetry agent intermediary 230 transmits the telemetry data 222 to a controller 240. The controller 240 is configured to perform data analytics and/or visualization of the telemetry data 222. The controller 240 is further configured to transmit the telemetry data 222, data analytics, and/or visualizations to a user device 260 via a network 250 in accordance with aspects of the embodiment described in FIG. 1. The user device is configured to display the telemetry data 222, data analytics, and/or visualizations on a graphical user interface in accordance with aspects of the various embodiments described herein.

The system 200 is configured to perform dynamic instrumentation in the observability session 202. During bootup of the software application 210, the telemetry agent 220 intercepts and/or patches the import statement 212. That is, the telemetry agent 220 can be initiated with zero instrumentation, and instrumentation can be loaded at runtime based on the configuration file 215 received from the source 216. The configuration file 215 can be changed during runtime, thus allowing instrumentation of the software application 210 using the one or more proxy objects 214 at any time. Since instrumentation configurations can be accepted by the one or more proxy objects 214 during runtime, the system 200 does not require an agent upgrade/restart to update instrumentation points or add new instrumentations. Thus, the techniques presented herein save time and resources associated with constant agent upgrades that may be needed for framework or library support. Further, the dynamic nature of the techniques presented herein provides enhanced capability to rollback or fix problematic instrumentations.

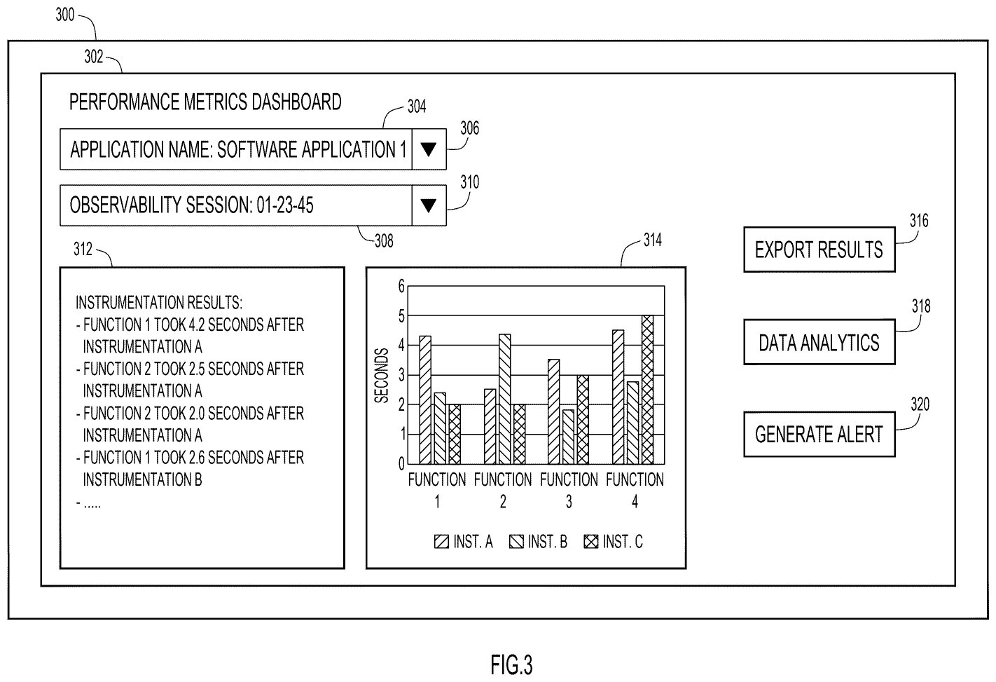

FIG. 3 is a diagram illustrating a graphical user interface displaying a performance metrics dashboard, according to an example embodiment. The graphical user interface 300 of a user device displays telemetry data, data analytics, and/or visualizations that a controller may report, in various embodiments described herein. For example, the graphical user interface 300 generates and displays a performance metrics dashboard 302. The performance metrics dashboard 302 includes a software application selection facility 304 implemented as a drop-down box with a button 306, when clicked, provides a user with a list of software applications currently monitored by telemetry agents in various embodiments described herein. Further, the performance metrics dashboard 302 includes an observability session selection facility 308 implemented as a drop-down box with a button 310, when clicked, provides the user with a list of observability session identifier associated with a corresponding software application selected by the user.

The performance metrics dashboard 302 displays reports and/or visualizations of performance measurements associated with the software application and observability session selected by the user. For example, report element 312 displays a textual report of instrumentation results from a specific observability session of “Software Application 1.” The instrumentation results include performance measurements (e.g., execution time) of various functions in the application. A visualization element 314 provides a chart visualizing the corresponding instrumentation results displayed in report element 312. It should be understood that report element 312 and visualization element 314 can provide other forms of report and/or visualization, including but not limited to summaries, graphs, flow diagrams, etc. Further, in certain embodiments, additional visualization elements not illustrated in FIG. 3 may be added to the performance metrics dashboard 302 based on user requirement.

The performance metrics dashboard 302 further includes a button 316 for exporting reports/visualizations, a button 318 for generating data analytics, and a button 320 for generating alerts. After the user evaluates the report and/or visualization displayed by report element 312 and/or visualization element 314, the user can export a report and/or visualization of the instrumentation results to another source by clicking on the button 316. Moreover, the user may determine that additional data analytics of the instrumentation results are desired. The performance metrics dashboard 302 displays additional options for data analytics in response to the user clicking on the button 318. Further, the user can generate alerts through the button 320. For example, the user (e.g., a system administrator) analyzes the reports and/or visualizations displayed and determines anomalies in the data pattern that require attention from other users/entities. The alert generation option allows the user to promptly address potential issues associated with the performance of a software application by providing an intuitive tool to notify the appropriate parties.

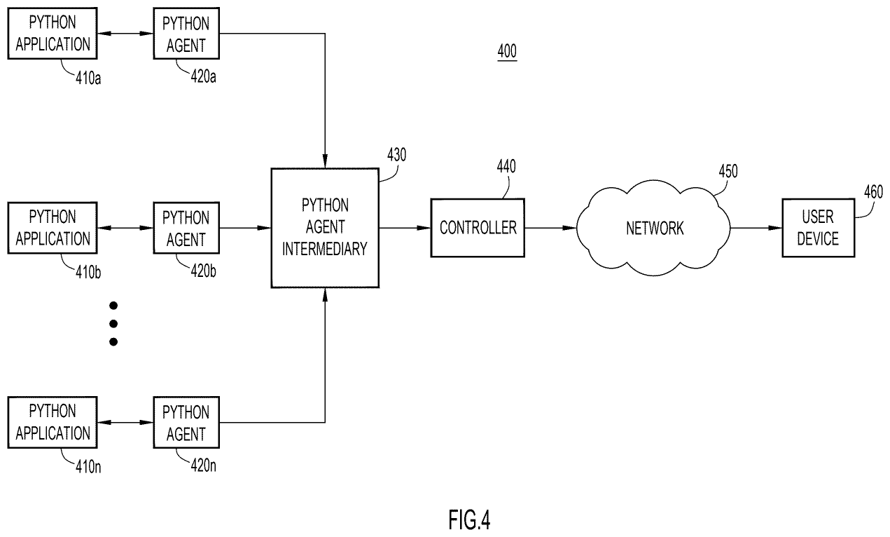

FIG. 4 is a block diagram illustrating a system 400 for providing observability sessions between Python® agents and Python applications, according to an example embodiment. Python is a registered trademark of the Python Software Foundation (PSF). In the system 400, each of applications 410a, 410b, . . . 410n (410a-n) is initiated with instructions to launch a process configured to initiate one of agents 420a, 420b, . . . 420n (420a-n) on bootup. For example, the application 410a is initiated with “opentelemetry-instrument <configs> <your-python-app-cmdline>” to set the PYTHONPATH variable and launch a process called <your-python-app-cmdline> in a Python environment. Once the agent 420a is initiated on bootup with the <your-python-app-cmdline> process, the agent 420a establishes an observability session with the application 410a.

After the observability session is established, the agent 420a patches an import statement in the code of the application 410a to generate one or more proxy objects. Instead of directly modifying behaviors of methods and classes in the application 410a using patching techniques such as monkey patching, the agent 420a patches the import statement to alter the behavior of the import statement. The import statement can be a direct or indirect import statement. For example, the agent 420a uses the “_builtins_._import_” method to monkey patch the import statement to generate one or more proxy objects.

The one or more proxy objects have the same behaviors as original objects in the software application. That is, for example, proxy methods are created for methods in the program, and proxy classes are created for classes in the program. Each proxy method/class mimics the behavior of the respective original method/class.

The one or more proxy objects of the application 410a are configured to accept a configuration file from a source during runtime. Based on the configuration file, the agent 420a instantiates one or more instrumentations using the one or more proxy objects by inserting the one or more instrumentations into the application 410a. Then, the agent 420a monitors and tracks application behaviors and/or performance measurements in response to the one or more instrumentations. The agent 420a is configured to provide the one or more instrumentations to the application 410a using the one or more proxy objects in accordance with aspects of the embodiments described in FIGS. 1 and 2.

The agent 420a reports telemetry data resulting from the observability session to an agent intermediary 430. Then, the agent intermediary 430 transmits the telemetry data to a controller 440. The controller 440 is configured to perform data analytics and/or visualization of the telemetry data. The controller 440 is further configured to transmit the telemetry data, data analytics, and/or visualizations to a user device 460 via a network 450 in accordance with aspects of the embodiments described in FIGS. 1 and 2. The user device is configured to display the telemetry data, data analytics, and/or visualizations on a graphical user interface in accordance with aspects of the embodiment described in FIG. 3.

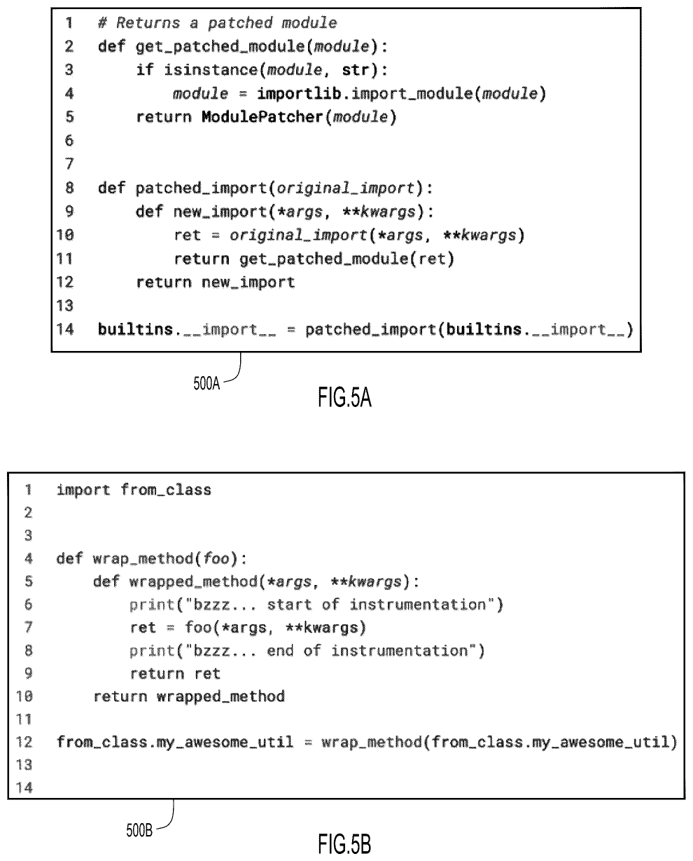

FIG. 5A is a diagram illustrating a program 500A (written using the Python programming language) with code for patching an import statement, according to an example embodiment. FIG. 5B shows a program 500B comprises code for monkey patching classes/methods that would need to be implemented if the techniques presented herein are not employed. Instead of monkey patching the classes, the techniques presented herein are configured to patch an import statement of a program. The program 500A (e.g., a file called “import_patcher.py”) comprises code for patching an import statement to return one or more proxy objects used for instrumenting an application (a Python application). In accordance with various aspects of the invention described herein, the program 500A is configured to alter the behavior of default import statements in an application to generate one or more proxy objects that can be used by an agent. The agent injects instrumentation at runtime based on a configuration file that specifies how the one or more proxy objects are instrumented.

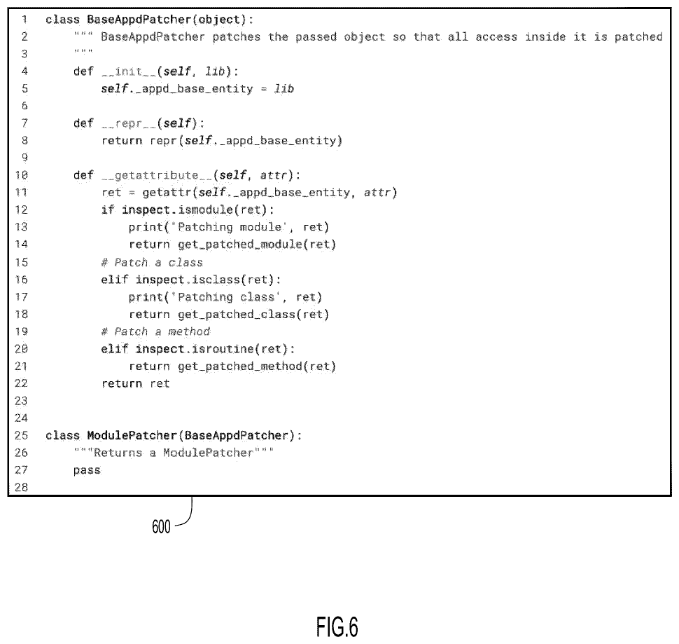

FIG. 6 is a diagram illustrating a program 600 with code (written in the Python programming language) for implementing module patching, according to an example embodiment. The program 600 comprises code for implementing a “ModulePatcher” configured to patch a module. In certain embodiments, the program 500A configured to patch an import statement, as illustrated in FIG. 5A, may call the “ModulePatcher” implemented in the program 600.

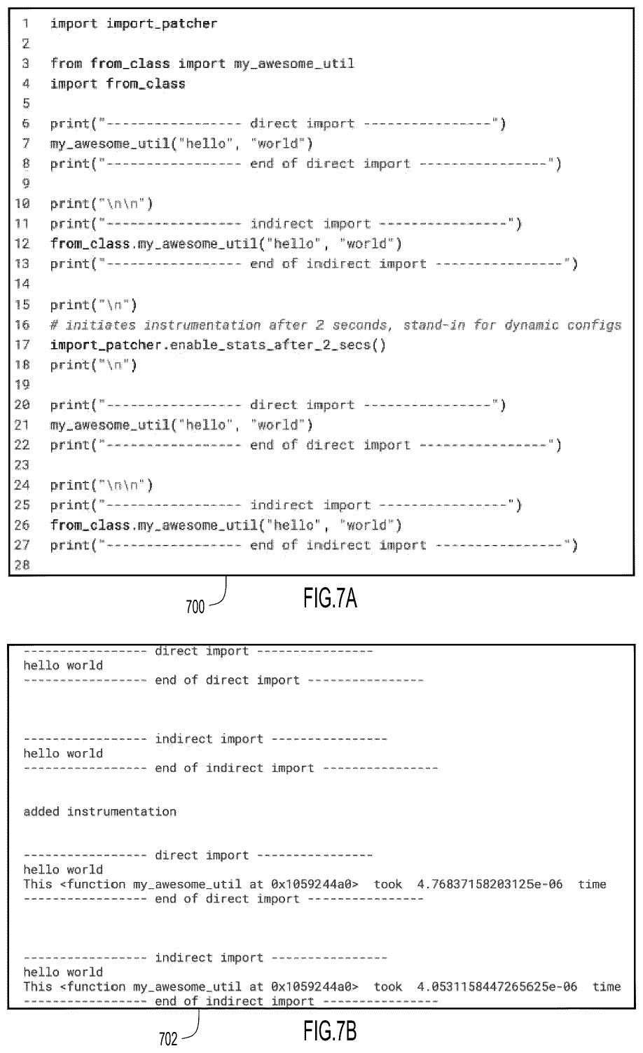

FIG. 7A is a diagram illustrating a program (written in the Python programming language) receiving instrumentation through import patching, according to an example embodiment. The program 700, through calling “import_patcher,” alters the behavior of the import statement to generate one or more proxy objects. Thus, when instrumentations are initiated during runtime, the program 700 is instrumented dynamically to add new classes/method. In certain embodiments, the program 700 makes two types of calls to my_awesome_util in the program. The program 700 uses direct import (e.g., “from from_class import my_awesome_util”). Moreover, the program 700 uses indirect import by first importing “from_class,” and then making calls “from_class.my_awesome_util.”

FIG. 7B shows instrumentation results 702 from the program 700. The instrumentation results 702 show that for both direct import and indirect import, import patching enables instrumentation to be added during runtime such that the program 700 consistently outputs performance measurements associated with a specific function. That is, for example, the instrumentation results 702 consistently include performance measurements using both direct and indirect import. The instrumentation results 702 are contrasted with inconsistent instrumentation results generated by a program that does not use import patching, which is described further below.

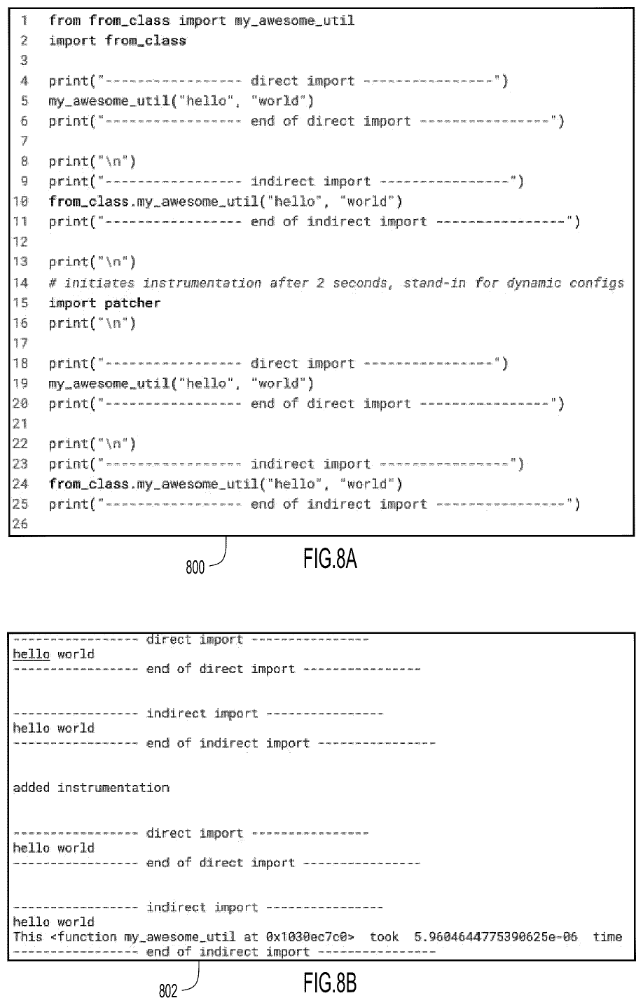

FIG. 8A is a diagram illustrating a program 800 (written using the Python programming language) being instrumented without import patching. The program 800 inserts instrumentations during runtime. For example, instrumentations are added after the program 800 executes a function using direct import and indirect import. Unlike the program 700, the import statements of the program 800 are not patched. FIG. 8B shows instrumentation results 802 from the program 800. The instrumentation results 802 show that the function was successfully instrumented using an indirect import (e.g., performance measurements are printed) while the function does not receive instrumentation when direct import is used. Thus, the instrumentation results 802 from the program 800 demonstrate that instrumentation without import patching may generate inconsistent results.

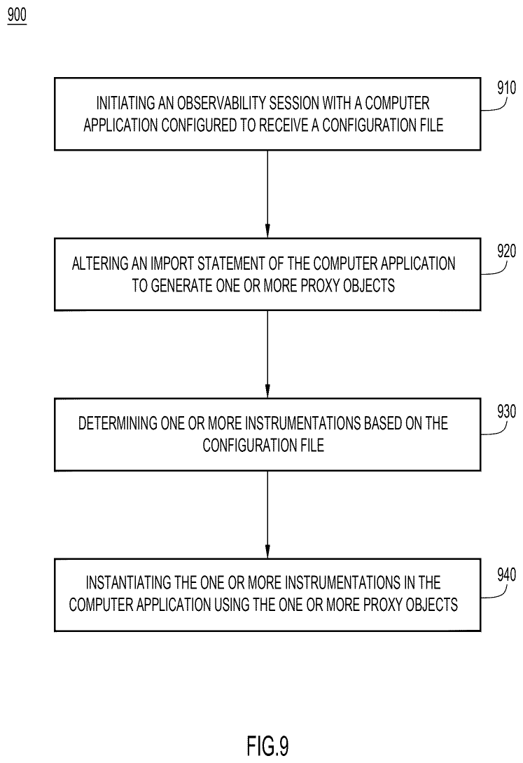

Reference is now made to FIG. 9, which is a flow diagram illustrating a computer-implemented method 900 for instantiating one or more instrumentations in a software application using one or more proxy objects, according to an example embodiment. The method 900 may be implemented by the telemetry agents 120a-n of FIG. 1.

At 910, the method 900 involves a telemetry agent initiating an observability session with a software application.

At 920, the method 900 involves the telemetry agent altering an import statement of the software application to generate one or more proxy objects.

At 930, the method 900 involves the telemetry agent determining one or more instrumentations based on a configuration file for the observability session.

At 940, the method 900 further involves instantiating the one or more instrumentations in the software application using the one or more proxy objects.

In the method 900, the observability session is initiated by injecting a script to the software application on bootup.

According to one or more example embodiments, the operation 940 of instantiating the one or more instrumentations includes inserting the one or more instrumentations into the software application using the one or more proxy objects and capturing telemetry data associated with the software application in response to the one or more instrumentations.

In the method 900, the import statement is one of a direct import statement or an indirect import statement.

In the method 900, the one or more proxy objects mimic one or more behaviors of one or more original objects of the software application.

In the method 900, the configuration file is configured to store one or more of: a module name, a method name, or one or more metrics to be tracked by the one or more instrumentations.

In the method 900, the configuration file is received from one or more of: a file system, a database, a server, a user, or an intermediary between the telemetry agent and a controller.

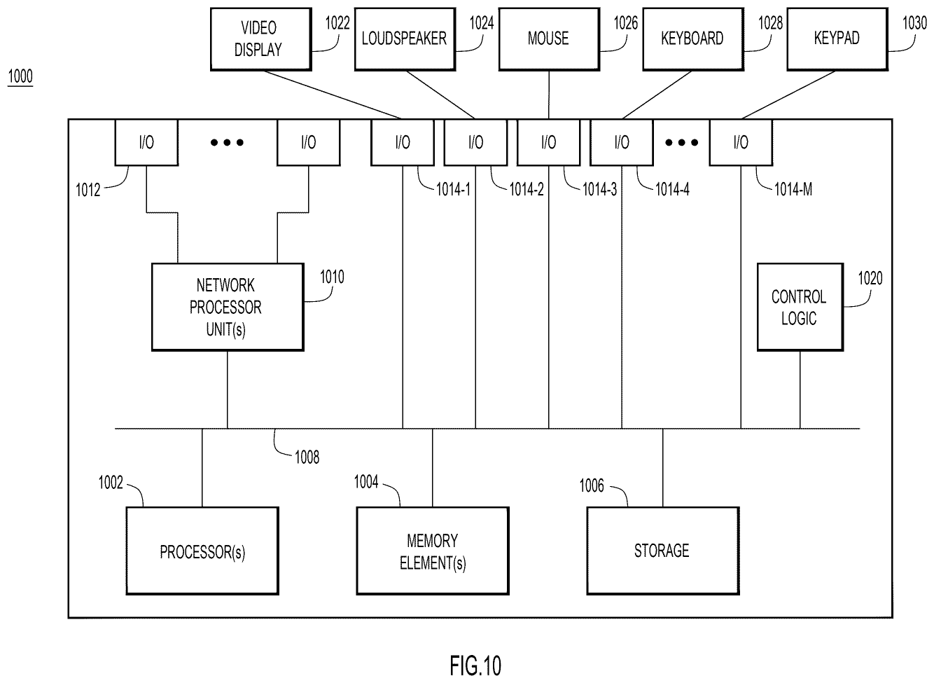

Referring to FIG. 10, FIG. 10 illustrates a hardware block diagram of a computing device 1000 that may perform functions associated with operations discussed herein in connection with the techniques depicted in FIGS. 1-4, 5A, 5B, 6, 7A, 7B and 9. In various embodiments, a computing device or apparatus, such as computing device 1000 or any combination of computing devices 1000, may be configured as any entity/entities as discussed for the techniques depicted in connection with FIGS. 1-4, 5A, 5B, 6, 7A, 7B and 9 in order to perform operations of the various techniques discussed herein.

In at least one embodiment, the computing device 1000 may be any apparatus that may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014-1, 1014-2, 1014-3, 1014-4, . . . , 1014-M, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory element(s) 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 (wired and/or wireless) to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014-1 to 1014-M allow for input and output of data and/or information with other entities that may be connected to computing device 1000. For example, I/O interface(s) 1014-1 to 1014-M may provide a connection to external devices such as a video display (e.g., touch-screen display) 1022, loudspeaker 1024, mouse 1026, keyboard 1028, keypad 1030, and/or any other suitable input and/or output device now known or hereafter developed. It is also envisioned that many of these external devices may be integrated as part of the computing device 1000. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one example, the techniques described herein relate to a computer-implemented method including: initiating, by a telemetry agent, an observability session with a software application; altering, by the telemetry agent, an import statement of the software application to generate one or more proxy objects; determining, by the telemetry agent, one or more instrumentations based on a configuration file for the observability session; and instantiating, by the telemetry agent, the one or more instrumentations in the software application using the one or more proxy objects.

In one example, the observability session is initiated by injecting a script to the software application on bootup.

In one example, wherein instantiating further includes: inserting the one or more instrumentations into the software application using the one or more proxy objects; and capturing telemetry data associated with the software application in response to the one or more instrumentations.

In one example, the import statement is one of a direct import statement or an indirect import statement.

In one example, the one or more proxy objects mimic one or more behaviors of one or more original objects of the software application.

In one example, the configuration file is configured to store one or more of: a module name, a method name, or one or more metrics to be tracked by the one or more instrumentations.

In one example, configuration file is received from one or more of: a file system, a database, a server, a user, or an intermediary between the telemetry agent and a controller.

In another example, the techniques described herein relate to an apparatus including: a network interface that enables network communications; a memory; and one or more processors coupled to the network interface and the memory, wherein the one or more processors are configured to perform operations including: initiating an observability session with a software application; altering an import statement of the software application to generate one or more proxy objects; determining one or more instrumentations based on a configuration file for the observability session; and instantiating the one or more instrumentations in the software application using the one or more proxy objects.

In still another example, the techniques described herein relate to one or more non-transitory computer readable storage media encoded with instructions that, when executed by a processor, cause the processor to: initiate an observability session with a software application; alter an import statement of the software application to generate one or more proxy objects; determine one or more instrumentations based on a configuration file for the observability session; and instantiate the one or more instrumentations in the software application using the one or more proxy objects.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
initiating, by a telemetry agent, an observability session with a software application;
altering, by the telemetry agent, an import statement of the software application to generate one or more proxy objects;
determining, by the telemetry agent, one or more instrumentations based on a configuration file for the observability session; and
instantiating, by the telemetry agent, the one or more instrumentations in the software application using the one or more proxy objects.

2. The computer-implemented method of claim 1, wherein the observability session is initiated by injecting a script to the software application on bootup.

3. The computer-implemented method of claim 1, wherein instantiating further comprises:
inserting the one or more instrumentations into the software application using the one or more proxy objects; and
capturing telemetry data associated with the software application in response to the one or more instrumentations.

4. The computer-implemented method of claim 1, wherein the import statement is one of a direct import statement or an indirect import statement.

5. The computer-implemented method of claim 1, wherein the one or more proxy objects mimic one or more behaviors of one or more original objects of the software application.

6. The computer-implemented method of claim 1, wherein the configuration file is configured to store one or more of: a module name, a method name, or one or more metrics to be tracked by the one or more instrumentations.

7. The computer-implemented method of claim 1, wherein the configuration file is received from one or more of: a file system, a database, a server, a user, or an intermediary between the telemetry agent and a controller.

8. An apparatus comprising:
a network interface that enables network communications;
a memory; and
one or more processors coupled to the network interface and the memory, wherein the one or more processors are configured to perform operations including:
initiating an observability session with a software application;
altering an import statement of the software application to generate one or more proxy objects;
determining one or more instrumentations based on a configuration file for the observability session; and
instantiating the one or more instrumentations in the software application using the one or more proxy objects.

9. The apparatus of claim 8, wherein the observability session is initiated by injecting a script to the software application on bootup.

10. The apparatus of claim 8, wherein instantiating further comprises:
inserting the one or more instrumentations into the software application using the one or more proxy objects; and
capturing telemetry data associated with the software application in response to the one or more instrumentations.

11. The apparatus of claim 8, wherein the import statement is one of a direct import statement or an indirect import statement.

12. The apparatus of claim 8, wherein the one or more proxy objects mimic one or more behaviors of one or more original objects of the software application.

13. The apparatus of claim 8, wherein the configuration file is configured to store one or more of: a module name, a method name, or one or more metrics to be tracked by the one or more instrumentations.

14. The apparatus of claim 8, wherein the configuration file is received from one or more of: a file system, a database, a server, a user, or an intermediary between a telemetry agent and a controller.

15. One or more non-transitory computer readable storage media encoded with instructions that, when executed by a processor, cause the processor to:
initiate an observability session with a software application;
alter an import statement of the software application to generate one or more proxy objects;
determine one or more instrumentations based on a configuration file for the observability session; and
instantiate the one or more instrumentations in the software application using the one or more proxy objects.

16. The one or more non-transitory computer readable storage media of claim 15,
wherein the observability session is initiated by injecting a script to the software application on bootup.

17. The one or more non-transitory computer readable storage media of claim 15, wherein the instructions are operable to cause the processor to instantiate the one or more instrumentations in the software application using the one or more proxy objects by:
inserting the one or more instrumentations into the software application using the one or more proxy objects; and
capturing telemetry data associated with the software application in response to the one or more instrumentations.

18. The one or more non-transitory computer readable storage media of claim 15, wherein the import statement is one of a direct import statement or an indirect import statement.

19. The one or more non-transitory computer readable storage media of claim 15, wherein the one or more proxy objects mimic one or more behaviors of one or more original objects of the software application.

20. The one or more non-transitory computer readable storage media of claim 15, wherein the configuration file is configured to store one or more of: a module name, a method name, or one or more metrics to be tracked by the one or more instrumentations, and wherein the configuration file is received from one or more of: a file system, a database, a server, a user, or an intermediary between a telemetry agent and a controller.
